(19) United States
(12) Patent Application Publication
(10) Pub. No.: US 2009/0141676 A1
(43) Pub. Date: Jun. 4, 2009

(54) METHOD AND APPARATUS FOR PROVIDING AN ERROR CONTROL SCHEME IN A MULTI-HOP RELAY NETWORK

(76) Inventors: Shashikant Maheshwari, Irving, TX (US); Tejas Bhatt, Irving, TX (US)

Correspondence Address: DITTHAVONG MORI & STEINER, P.C., 918 Prince St., Alexandria, VA, 22314, US

(21) Appl. No.: 11/939,999

(22) Filed: Nov. 14, 2007

Related U.S. Application Data
(60) Provisional application No. 60/865,779, filed on Nov. 14, 2006.

(51) Int. Cl. H04W 72/14; H04L 12/28

(52) U.S. Cl. 370/329; 370/431; 714/749

(57) ABSTRACT

An approach provides an error-control scheme within a multi-hop relay network. A determination is made of a first node that failed to transmit a packet generated according to an error-control scheme, wherein the first node is among a plurality of nodes configured to operate in a multi-hop network. Resources of the multi-hop network are reserved only for retransmission of the packet from the first node towards a destination node that is included in the plurality of nodes.

### RELATED APPLICATIONS

This application claims the benefit of the earlier filing date under 35 U.S.C. §119(e) of U.S. Provisional Application Ser. No. 60/865,779 filed Nov. 14, 2006, entitled “Method and Apparatus for Providing Hybrid-Automatic Repeat Request (H-ARQ) Error Control in a Multi-Hop Relay Network,” the entirety of which is incorporated herein by reference.

### BACKGROUND

Radio communication systems, such as a wireless data networks (e.g., Institute of Electrical and Electronic Engineers (IEEE) 802.16), provide users with the convenience of mobility along with a rich set of services and features. This convenience has spawned significant adoption by an ever growing number of consumers as an accepted mode of communication for business and personal uses. To promote greater adoption, the telecommunication industry, from manufacturers to service providers, has agreed at great expense and effort to develop standards for communication protocols that underlie the various services and features. This challenge is particularly acute when multiple networks are required to interoperate in providing error control schemes that efficiently utilize networking resources (e.g., bandwidth, processing, etc.).

### SOME EXEMPLARY EMBODIMENTS

Therefore, there is a need for an approach for effectively combating transmission errors in a manner that is efficient and maximizes use of standardized protocols. The approach, according to certain embodiments, selectively transmits error control feedback messages from a first node (of a multi-hop network) in which transmission of an error control message was not successful. Additionally, the system only allocates resources for this first node and subsequent nodes in the multi-hop network through to an end node.

According to one embodiment of the invention, a method comprises determining a first node that failed to transmit a packet generated according to an error-control scheme, wherein the first node is among a plurality of nodes configured to operate in a multi-hop network. The method also comprises reserving resources of the multi-hop network only for retransmission of the packet from the first node towards a destination node that is included in the plurality of nodes.

According to another embodiment of the invention, an apparatus comprises a scheduler configured to determine a first node that failed to transmit a packet generated according to an error-control scheme. The first node is among a plurality of nodes configured to operate in a multi-hop network. Resources of the multi-hop network are reserved only for retransmission of the packet from the first node towards a destination node that is included in the plurality of nodes.

According to another embodiment of the invention, a system comprises a plurality of relay stations configured to operate in a multi-hop network. The system also comprises a base station configured to communicate with each of the relay stations. The base station is further configured to determine a first relay station, among the plurality of relay stations, that failed to transmit a packet generated according to an error-control scheme. The base station is further configured to reserve resources of the multi-hop network only for retransmission of the packet from the first node towards a destination node that is included in the plurality of nodes.

According to another embodiment of the invention, a method comprises determining transmission failure of a packet generated according to an error-control scheme to a subsequent node among a plurality of nodes of a multi-hop network, wherein the plurality of nodes include a source node and a destination node. The method also comprises notifying the source node of the failure to the subsequent node, wherein resources of the multi-hop network are reserved only for retransmission of the packet to the subsequent node towards the destination node.

According to yet another embodiment of the invention, an apparatus comprises logic configured to determine transmission failure of a packet generated according to an error-control scheme to a subsequent node among a plurality of nodes of a multi-hop network, wherein the plurality of nodes include a source node and a destination node. The logic is further configured to notify the source node of the failure to the subsequent node. Resources of the multi-hop network are reserved only for retransmission of the packet to the subsequent node towards the destination node.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of an architecture of a wireless multi-hop relay network capable of providing error control, in accordance with various embodiments of the invention;

FIG. 2 is a diagram of an exemplary frame structure for the multi-hop relay network of FIG. 1, in accordance with various embodiments of the invention;

FIG. 3 is a diagram of a base station capable of scheduling resources in response to feedback information from a mobile station or a relay station, in accordance with an embodiment of the invention;

FIG. 4 is a flowchart of a process for providing a Hybrid Automatic Repeat Request (H-ARQ) scheme in the multi-hop relay network of FIG. 1, in accordance with an embodiment of the invention;

FIGS. 5A and 5B are diagrams of multi-hop systems capable of utilizing an H-ARQ scheme, according to an embodiment of the invention;

FIGS. 6A-6D are ladder diagrams of exemplary scenarios involving the use of an H-ARQ scheme, according to various embodiments of the invention; and

FIG. 7 is a diagram of hardware that can be used to implement an embodiment of the invention.

### DESCRIPTION OF PREFERRED EMBODIMENTS

An apparatus, method, and software for providing error control in a communication network are disclosed. In the following description, for the purposes of explanation, numerous specific details are set forth in order to provide a thorough understanding of the embodiments of the invention. It is apparent, however, to one skilled in the alt that the embodiments of the invention may be practiced without these specific details or with an equivalent arrangement. In other instances, well-known structures and devices are shown in block diagram form in order to avoid unnecessarily obscuring the embodiments of the invention.

Although the embodiments of the invention are discussed with respect to a wireless network compliant with the IEEE 802.16 architecture (i.e., also referred to as “WirelessMAN” or WiMax (Worldwide Interoperability for Microwave Access)) with respect to the Hybrid Automatic Repeat Request (H-ARQ) scheme, it is recognized by one of ordinary skill in the art that the embodiments of the inventions have applicability to any type of radio communication system and equivalent error control schemes.

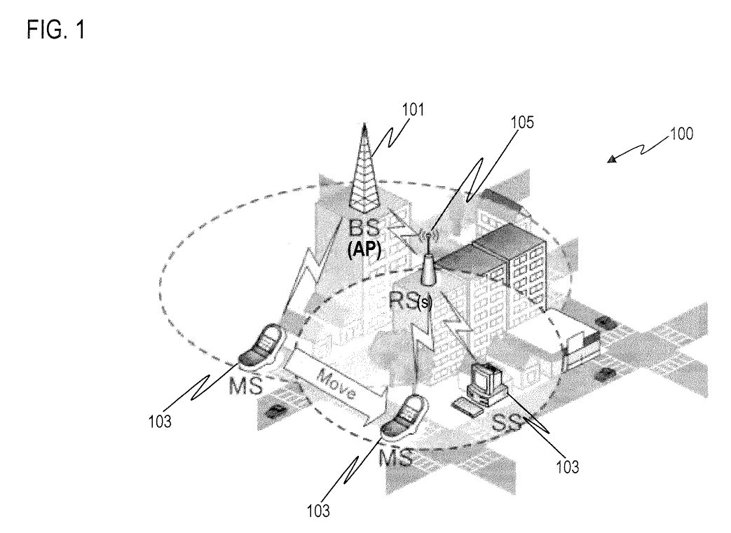

FIG. 1 is a diagram of an architecture of a wireless multi-hop relay network capable of providing error control, in accordance with various embodiments of the invention. By way of example, a communication system 100 is compliant with IEEE Std. 802.16d-2004 as amended by IEEE Std 802.16e-2005, entitled “IEEE Standard for Local and Metropolitan Area Network,” 2005 Ed. (which is incorporated herein by reference in its entirety). In an exemplary embodiment, the system 100 is a wireless relay network (i.e., multi-hop system) in which one or more end nodes (e.g., mobile station (MS)/subscriber station (SS)) 103 are connected to a base station (BS) (or access point (AP)) 101 via one or more relay station(s) (RSs) 105. The system 100 employs relay stations 105 to extend the network coverage and/or enhance the system throughput. The relay station 105 can be either a base-station like fixed device, or a mobile device (such as a laptop, personal digital assistant (PDA), car or cellular phone) acting as a relay for other devices.

An exemplary usage scenario of the relay station 105 is shown in FIG. 1, whereby traffic Between MS/SSs 103 and BS/AP 101 passes through the RS 105. An area of interest is that of error control involving the BS 101, the RS 105, and the MS 103.

In an exemplary embodiment, according to IEEE 802.16, Hybrid automatic repeat request (H-ARQ) scheme is a part of medium access control (MAC) layer and can be enabled in a per-terminal basis. The H-ARQ scheme combines ARQ protocols with forward-error-correction (FEC) schemes, and is generally considered to be a sound error-control technique for wireless links. It is noted that different wireless technology may utilize different H-ARQ schemes. Two main variants of H-ARQ are supported: Chase Combining or Incremental Redundancy (IR). For IR, the physical (PHY) layer encodes the information bits generating four versions of the encoded packet corresponding to four H-ARQ attempts (of which the first version must be transmitted at least once). Each H-ARQ attempt is uniquely identified using an H-ARQ attempt identifier (SPID). For Chase Combining, the PHY layer encodes the H-ARQ packet generating only one version of the encoded packet. As a result, no SPID is required for Chase Combining. As used herein, the generic term “H-ARQ attempt” is used to represent H-ARQ attempt for IR or chase combining and the only version of the encoded packet.

For downlink operation (i.e., traffic from the base station 101 towards the mobile station 103), according to an exemplary embodiment, the BS 101 sends a version of the encoded H-ARQ packet. The MS/SS 103 then attempts to decode the encoded packet on this first H-ARQ attempt. If the decoding succeeds, the MS/SS 103 sends an acknowledgement (ACK) to the BS 101. Otherwise, a negative acknowledgement (NAK) is sent to the BS 101. In the response to NAK, the BS 101 sends another H-ARQ attempt. The BS 101 may continue to send H-ARQ attempts until the MS/SS 103 successfully decodes the packet and sends an ACK or the max number of retransmissions is exhausted.

It is recognized that the H-ARQ scheme, in general, works well in a communication system that does not utilize relay stations 105, where H-ARQ scheme is directly applied between the BS 101 and MS/SS 103. However, when a RS 105 is introduced into the system, two scenarios are considered: (1) perform the HARQ over each hop on a hop-by-hop basis; and (2) H-ARQ implemented between the MS/SS 103 and BS 101. In the first scenario, HARQ is utilized over each hop on a hop-by-hop basis, i.e., per link basis. Unfortunately, this increases the delay significantly and is not effective for delay sensitive applications (e.g., Voice over IP (VoIP)). Also, in case of centralized scheduling, where BS 101 controls the resource allocation on each link, this scheme is not feasible. As for the second scenario, the RS 105 forwards all the H-ARQ attempts as well as ACK/NAKs between the MS/SS 103 and BS 101.

The system 100, according to an exemplary embodiment, provides an enhanced H-ARQ scheme that provides better bandwidth utilization over traditional schemes. It is noted that this approach can be applied to relay in various wireless technology, although WiMax mobile multi-hop relay (MMR) is described.

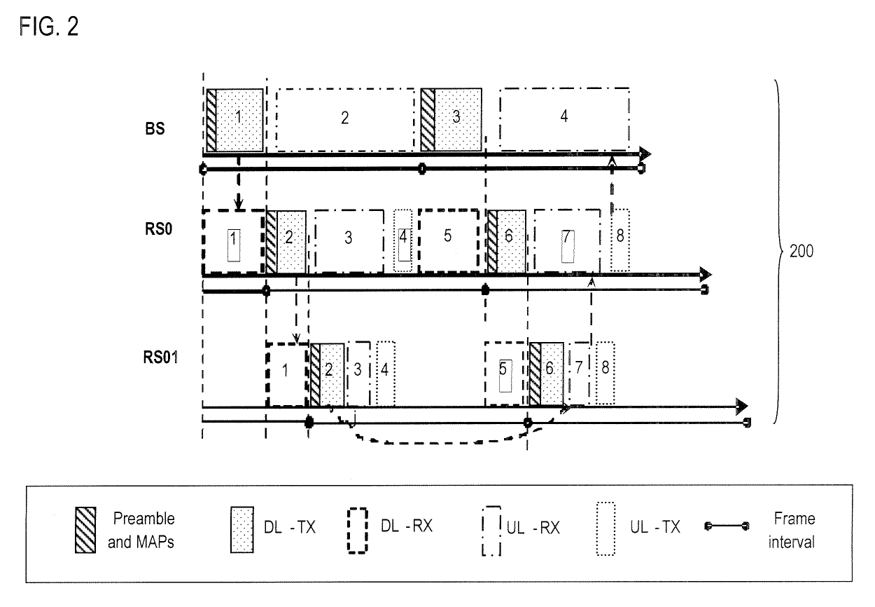

FIG. 2 is a diagram of an exemplary frame structure for the multi-hop relay network 100 of FIG. 1, in accordance with various embodiments of the invention. Continuing with the example of FIG. 1, for minimum propagation delay for the downlink traffic, H-ARQ attempt(s) are sent from BS 101 to MS 103 via multiple hops, and ACKs are transmitted back from MS 103 to BS 101, all in the single frame structure 200. In this example, BS 101 transmits the HARQ attempt to RS0 in block 1. If RS0 receives the packet successfully, RS0 203 transmits the HARQ attempt to RS01 in the RS0 block 2. If RS01 receives the HARQ attempt successfully, this relay station then transmits the HARQ attempt to MS 103 in RSOI block 2. At this point, the ACK is sent back from MS 103 to BS 101. If MS 103 receives HARQ attempt successfully, the MS 103 replies with an ACK in RS01 block 7, which is relayed to RS0 in RS01 block 8. RS0 203 relays the ACK back to BS 101 in RS0 203 block 8.

When HARQ packet is sent over multiple hops, the transmission can fail at any hop. Conventionally, if the BS 101 does not know at which hop the HARQ packet failed, the BS 101 simply retransmits HARQ packet, resulting in the transmission of subsequent H-ARQ attempt(s) over all the different hops (links) between BS101 and MS/SS 103. Bandwidth is re-allocated between BS 101 to MS 103 for transmitting the subsequent H-ARQ attempt(s), even though some of the links may have already transferred the frame successfully. Consequently, network resources are wasted—e.g., bandwidth, and throughput loss results. For multi-hop relay transmission with the independent links, the overall probability, arguably, of the unsuccessful H-ARQ attempt is the sum of failure probability of each link between the source node (e.g., BS 101) and destination node (e.g., MS/SS 103).

As mentioned, traditionally, if the first H-ARQ attempt is not sent successfully due to error or loss, another H-ARQ attempt is sent until the MS/SS 103 or BS 101 successfully decodes the H-ARQ packet. Therefore, the subsequent H-ARQ attempt(s) needs to be transmitted over all the different hops (links) between BS 101 and MS/SS 103. Bandwidth is re-allocated between BS 101 to MS 103 for transmitting the subsequent H-ARQ attempt(s), even though some of the links may have already transferred the frame successfully. This results in inefficient use of valuable radio resources (e.g., bandwidth and power), and a decrease in throughput.

If the H-ARQ is directly applied between MS/SS 103 and BS 101 as defined in the system without RS 105, the RS 105 just simply forwards the H-ARQ attempts and ACK/NAKs between MS/SS 103 and BS 101 without any processing.

According to one embodiment, to optimize the bandwidth utilization and spectrum efficiency, and to lower latency, an enhanced H-ARQ scheme provides that when an H-ARQ attempt is lost or received erroneously over a hop between BS 101 and MS/SS 103, then only the first node in the multi-hop chain that received the packet successfully but failed to transmit the packet to the next hop, transmits another H-ARQ attempt. In case of centralized scheduling, BS 101 schedules resources for all the links.

Therefore, BS 101 needs to know at which hop the HARQ packet is lost so that the BS 101 can keep the resources reserved for the those hops over which the packet is not transmitted successfully. The BS 101 determines the first node that fails on decoding based on the feedback information sent from the nodes on the path. This also allows BS 101 to release and/or re-direct resources of the links over which the packet was transmitted successfully and reserve the resources only for the links after the first node over which the transmission failed. Thus, BS 101 can provide better radio resource utilization, thereby improving the overall bandwidth efficiency and throughput of multi-hop relay network. Lack of such knowledge would require BS 101 to initiate retransmission and lead to inefficient usage of radio resources, namely bandwidth and power.

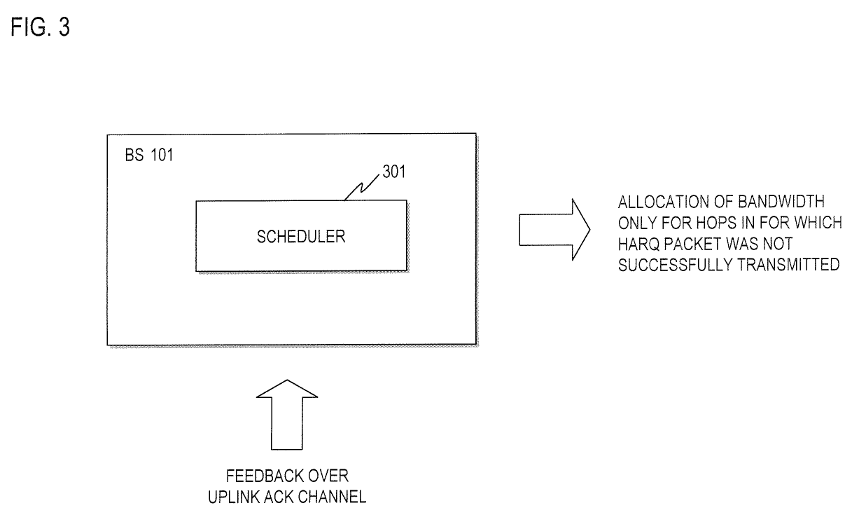

FIG. 3 is a diagram of a base station capable of scheduling resources in response to feedback information from a mobile station or a relay station, in accordance with an embodiment of the invention. In this example, a centralized scheduling approach is provided. A scheduler 301 (or other equivalent logic) within in BS 101 schedules the resources for all the appropriate links. Therefore, BS 101 has knowledge of the particular hop the HARQ packet was lost, such that the BS 101 can maintain the resources reserved for those hops over which the packet was not transmitted successfully. In an exemplary embodiment, the BS 101 determines the first node that fails on decoding based on the feedback information sent from the nodes along the path. By way of example, the feedback can be provided using a designated uplink channel.

For example, the HARQ mechanism in IEEE 802.16 provides a synchronous UL ACK Channel in which the MS 103 sends ACK/NACK information based on decoding result of HARQ packet. If an HARQ packet is transmitted in frame N, then synchronous UL ACK channel is reserved in a designated frame (e.g., N+HARQ_DL_ACK_DELAY frame). This UL ACK channel can be utilized, according to an exemplary embodiment, to send feedback information from MS 103 to RS 105 about the failed transmission.

According to certain embodiments, the uplink ACK (Acknowledgement) provides feedback for downlink HARQ. The SS/MS transmits ACK or NAK feedback for downlink packet data. One ACK channel occupies a half subchannel, which is three pieces of 3×3 uplink tile in the case of optional partial usage of subchannels (PUSC) or three pieces of 4×3 uplink tile in the case of PUSC. The even half subchannel can include Tile (0), Tile (2), and Tile (4). The odd half subchannel can include Tile (1), Tile (3), and Tile (5). The acknowledgement bit of the nth ACK channel can be ‘0’ (ACK), if the corresponding downlink packet has been successfully received; otherwise, the bit can be ‘1’ (NAK). This ACK or NAK bit, for instance, is encoded into a length 3 code-word over 8-ary alphabet for the error protection as shown in below. Table 1 lists an exemplary ACK/NAK encoding scheme:

TABLE 1

| | Vector Indices per Tile |
|---|---|
| ACK/NAK 1-bit symbol | Tile(0), Tile(1), Tile(2) |
| 0 (ACK) | 0, 0, 0 |
| 1 (NAK) | 4, 7, 2 |

Vector indices are defined in Table 2 (Orthogonal Modulation Index in UL ACK Channel):

TABLE 2

| Vector index | Mn, 8 m, Mn, 8 m + 1, . . . , Mn, 8 m + 7 |
|---|---|
| 0 | P0, P1, P2, P3, P0, P1, P2, P3 |
| 1 | P0, P3, P2, P1, P0, P3, P2, P1 |
| 2 | P0, P0, P1, P1, P2, P2, P3, P3 |
| 3 | P0, P0, P3, P3, P2, P2, P1, P1 |
| 4 | P0, P0, P0, P0, P0, P0, P0, P0 |
| 5 | P0, P2, P0, P2, P0, P2, P0, P2 |
| 6 | P0, P2, P0, P2, P2, P0, P2, P0 |
| 7 | P0, P2, P2, P0, P2, P0, P0, P2 |

where, P0=exp(j.π/4); P1=exp(j.3π/4); P2=exp(−j.3π/4); and P3=exp(−j.π/4).

It can be seen that when SS/MS 103 transmits 0 (ACK), SS/MS 103 transmits a sequence of 0 0 0 vector indices, which are mapped to UL ACK Channel tile. Similarly when SS/MS 103 transmits 1 (NAK), the SS/MS 103 transmits sequence of 4 7 2. BS 101 demodulates the sequence and decode whether it is ACK or NAK.

A more detailed description of the multi-hop relay processing is provided in IEEE P802.16j/D1, entitled “Air Interface for Fixed and Mobile Broadband Wireless Access Systems; Multi-hop Relay Specification,” which is incorporated herein by reference in its entirety. (August 2007) (hereinafter denoted by “IEEE P802.16j/D1”).

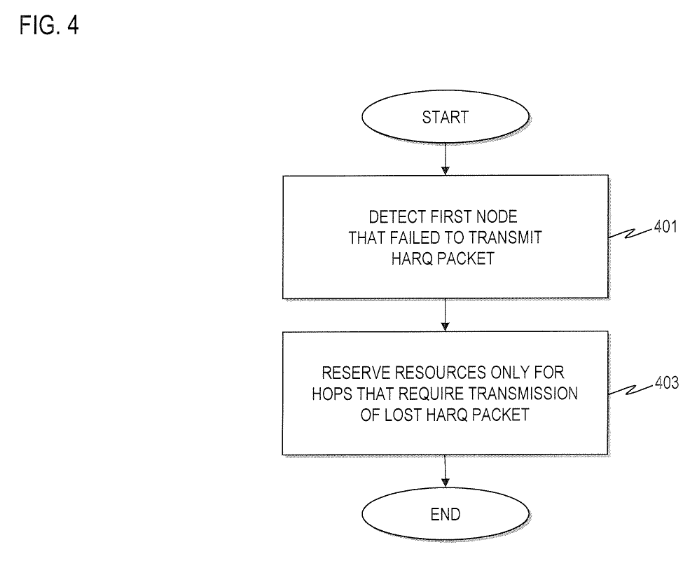

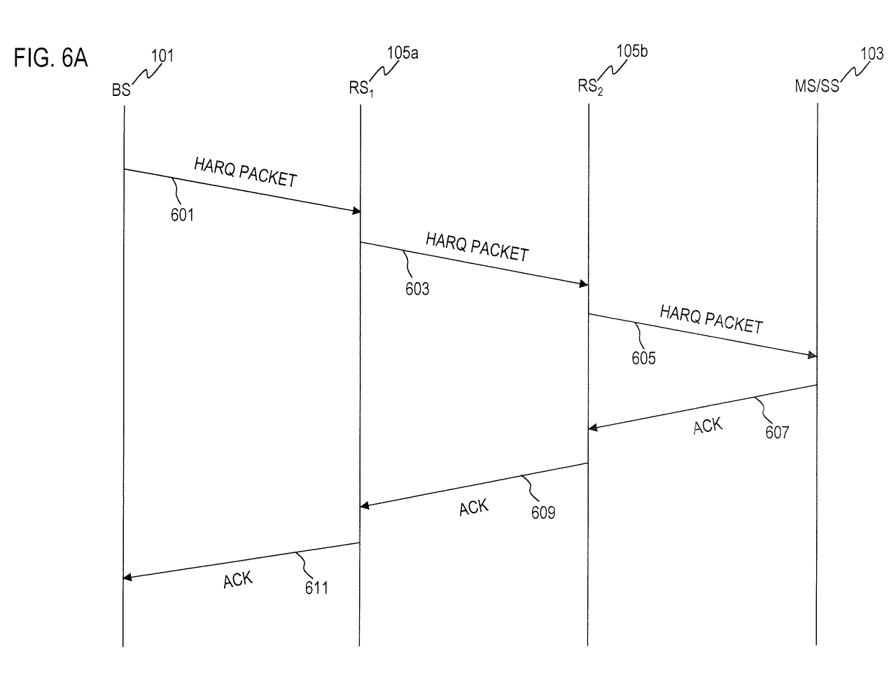

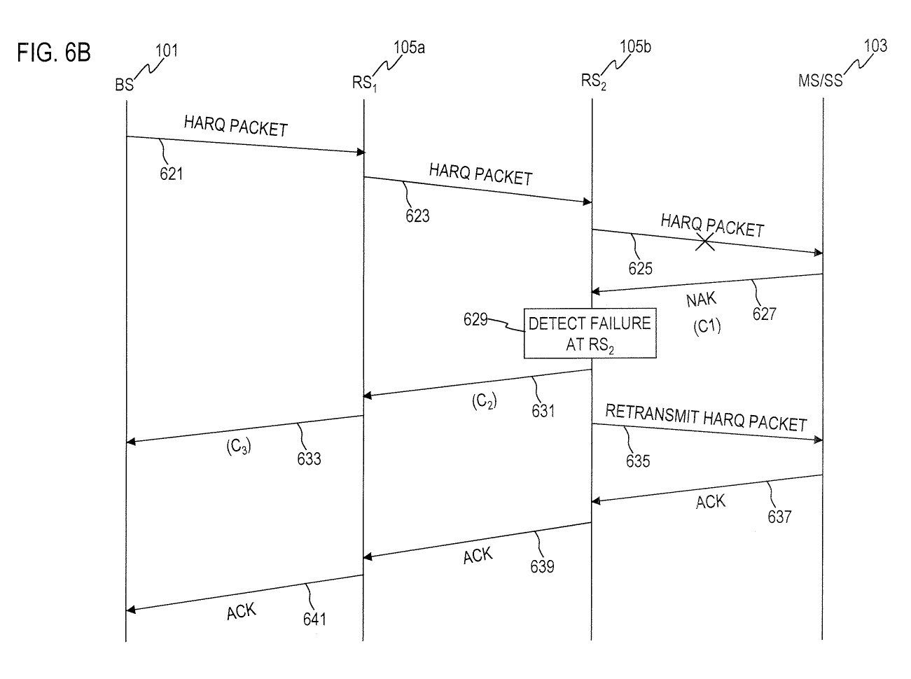

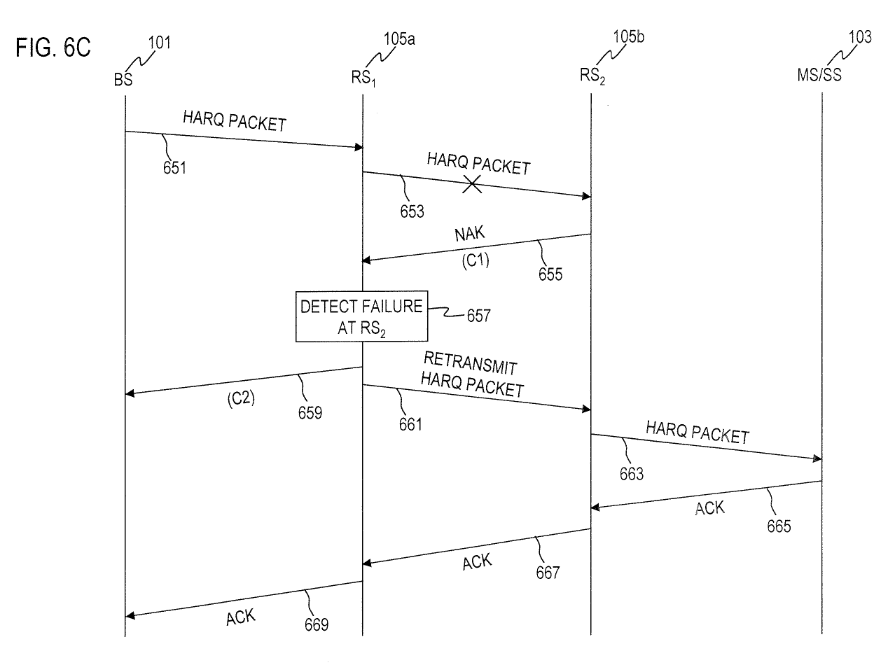

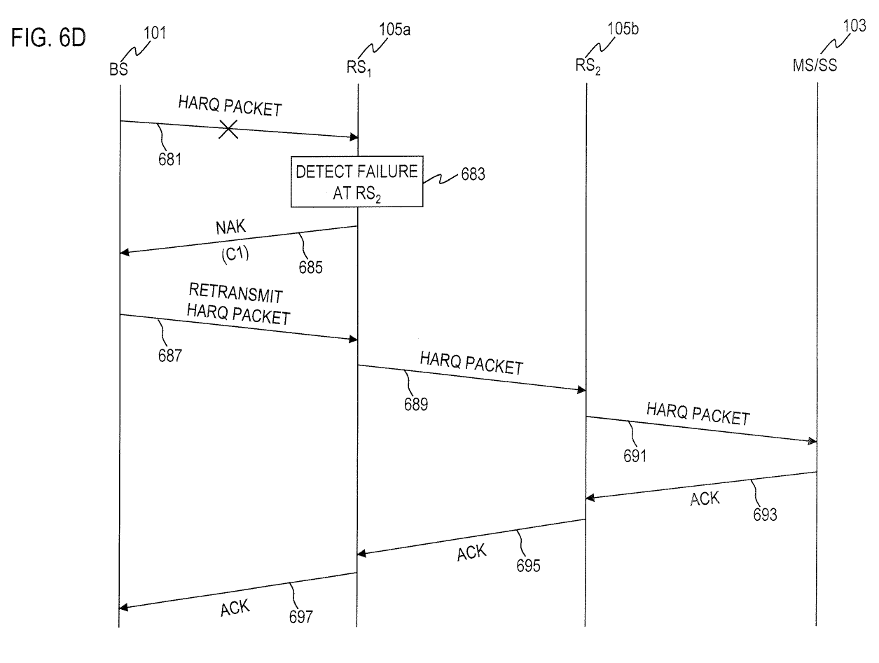

FIG. 4 is a flowchart of a process for providing a Hybrid Automatic Repeat Request (H-ARQ) scheme in the multi-hop relay network of FIG. 1, in accordance with an embodiment of the invention. In step 401, BS 101 detects a first node that failed to transmit HARQ packet. This first node could be the base station 101, any intermediate node (e.g., relay station 105), or the mobile station 103. It is noted however that in downlink scenario, the mobile station 103 would not be the first node; further, if the base station 101 fails to transmit properly, conventional retransmission can be performed. If BS 101 detects a node failed to transmit, the BS 101 reserves resources, per step 403, only for hops that require transmission of lost HARQ packet. The above process is further detailed below with respect to FIGS. 6A-6D.

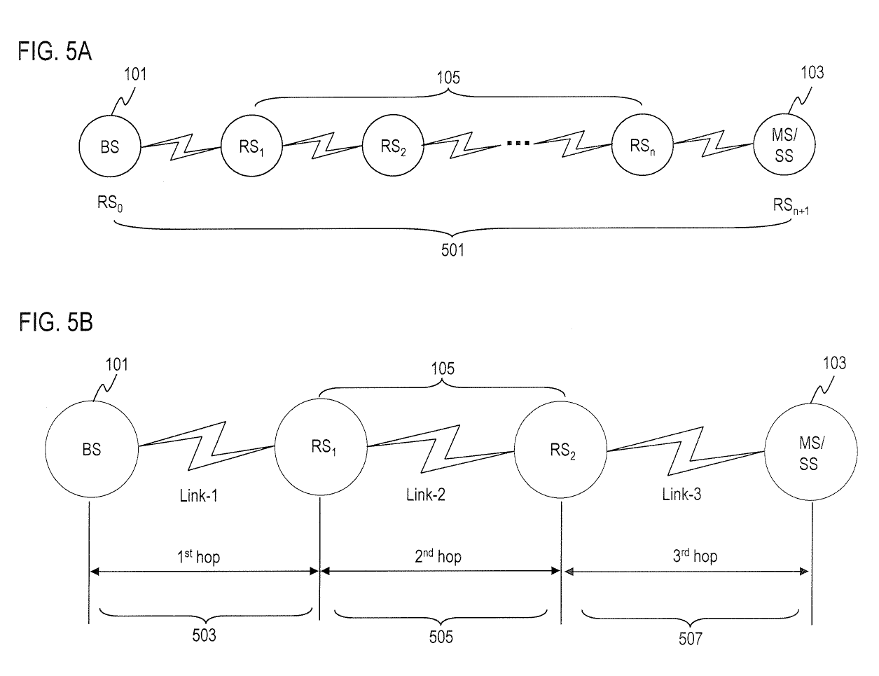

FIGS. 5A and 5B are diagrams of multi-hop systems capable of utilizing an H-ARQ scheme, according to an embodiment of the invention. In an exemplary scenario, a certain number (e.g., n) RSs are employed over a link 501 between BS 101 and MS 103, as shown in FIG. 5A. According to one notational scheme, RS₀ would be BS 101, and RSₙ₊₁ is the MS/SS 103. According to one embodiment, new sequences can be defined to notify the BS 101 where exactly the HARQ packet is lost over the multiple hops 503-507. These sequences can be sent by the RS(s) 105 over the UL ACK channel (which has been defined to transport ACK/NAK signaling). The link 503 between the BS (RS₀) 101 and RS₁ can be denoted as 1^{st} hop, the link 505 between RS₁ and RS₂ as 2^{nd} hop, and so on. For the purposes of illustration, the links 503-507 between BS-RS₁ (Link 1), RS₁-RS₂ (Link 2) and RS₂-MS/SS (Link 3) are labeled sequentially as shown, in which the link-label also defines the depth of the link 501.

According to an exemplary embodiment, the new sequences are defined to uniquely identify the failed link. Further, it should be noted that BS 101 only needs to identify the failed link—i.e., if the HARQ attempt fails between adjacent relay stations, RSⱼ and RSⱼ₊₁, then BS identifies RSⱼ. It is also assumed that for the HARQ packet under consideration, no transmission can take place from RSⱼ₊₁ onwards.

It is noted that the vectors in Table 2 define orthogonal modulation sequences, that is Vᵢ*Vⱼ^{H}=0, for i˜=j, where (.)^{H} denotes the Hermitian transpose and Vᵢ[i∈{0, 1, . . . , 7}] is the modulation vector corresponding to index i. One instance of the sequences can be generated by using the unused vector indices (1, 3 and 5) to generate a unique code, and the rest of the codes can be generated using cyclic shifts of two sequences (4, 7, 2) and (3, 5, 1). This scheme is further explained in Table 3a for a hop-distance of 5, i.e., 4 relay stations, BS and MS/SS. It should be noted that the scheme can be extended further if more hops are involved.

TABLE 3a

| | | Vector Indices per | |
|---|---|---|---|
| | | Tile | |
| Link | ACK/NAK 1-bit | Tile(0), Tile(1), | |
| Distance/Depth | symbol | Tile(2) | Code # |
| Any Distance | 0 (ACK) | 0, 0, 0 | C₀ |
| 1 | 1 (NAK) | 4, 7, 2 | C₁ |
| 2 | 1 (NAK) | 3, 5, 1 | C₂ |
| 3 | 1 (NAK) | 7, 2, 4 | C₃ |
| 4 | 1 (NAK) | 5, 1, 3 | C₄ |
| 5 | 1 (NAK) | 2, 4, 7 | C₅ |

In Table 3b, the codes are defined such that they are not necessarily cyclic shifts of any of the sequence.

TABLE 3b

| | | Vector Indices per | |
|---|---|---|---|
| | | Tile | |
| Link | ACK/NAK 1-bit | Tile(0),Tile(1), | |
| Distance/Depth | symbol | Tile(2) | Code # |
| Any Distance | 0 (ACK) | 0, 0, 0 | C₀ |
| 1 | 1 (NAK) | 4, 7, 2 | C₁ |
| 2 | 1 (NAK) | 3, 5, 1 | C₂ |
| 3 | 1 (NAK) | 6, 2, 3 | C₃ |
| 4 | 1 (NAK) | 5, 1, 7 | C₄ |
| 5 | 1 (NAK) | 2, 6, 5 | C₅ |

FIGS. 6A-6D are ladder diagrams of exemplary scenarios involving the use of an H-ARQ scheme, according to various embodiments of the invention. According to the following four exemplary scenarios, as shown in the FIGS. 6A-6D, BS 101 transmits HARQ packet to MS 103 in frame N.

In FIG. 6A, HARQ packet is transmitted, per steps 601-605, successfully at all the links but the MS/SS 103. In step 607, the MS 103 sends an ACK to RS2, which in turn sends ACK to RS1, as in step 609. Next, RS1 transmits an ACK to BS 601 (step 611), all in N+HARQ_DL_ACK_DELAY frame.

In FIG. 6B, if HARQ packet is successfully received by RS1 and RS2 (steps 621 and 623), but failed on link-3 (between RS2-MS), as in step 625. In step 627, the MS 103 sends the original NAK sequence, referred to as (C₁) to RS2 615 in the N+HARQ_DL_ACK_DELAY frame. RS2 is made aware that the packet transmission failed on its link (step 629), accordingly the RS2 stores the packet in its queue and transmits 2^{nd} hop code sequence (C₂) as defined in Table 3a or Table 3b to RS1, per step 631.

When RS1 receives the 2^{nd} hop code sequence (C₂) instead of original ACK/NAK code sequences ((C₀/C₁), RS1 knows that the packet was received successfully on the next hop, but failed on the link that is 2 hops away from itself. RS0 611 clears the packet from its queue and transmits 3^{rd} hop code sequence (C₃), as in step 633—i.e., (received code sequence+1)—to upstream node (in the current example, to BS 101). BS 611 upon receipt of 3^{rd} hop code sequence (C₃) in UL ACK Channel assumes that packet is lost on the link that is 3 hops away and clears its queue. This acts as an implicit request to keep the resources reserved on the 3^{rd} hop, or in general 3^{rd} hop onwards.

RS2 will retransmit the HARQ packet in N+HARQ_DL_ACK_DELAY+HARQ_NECT_RETRANS_DELAY frame, per step 635. At this point, the MS 103 can send an ACK in response to the receipt of the retransmitted HARQ packet; this ACK is forwarded to the RS2, then RS1, and subsequently BS 101 (steps 637-641).

In the scenario of FIG. 6C, the HARQ packet is transmitted by the BS 101, as in step 651, and is received successfully by RS1. However, the packet is then transmitted by the RS1 to RS2, but experiences a transmission failure (i.e., link-2 failed) (step 653). In this case, RS2 transmits the original NAK code sequence defined for 1^{st} hop (C₁) to RS1, per step 655, in UL ACK channel slot specified for RS2-to-RS1.

In step 657, RS1 knows that it has received the packet successfully, but that the packet transmission failed at the next hop (RS2). Consequently, RS1 keeps the received packet in its queue and transmits 2^{nd} hop code sequence (C₂), as defined in Table 3a or Table 3b to upstream node (in this case, to BS), as in step 659. RS1 also retransmits the HARQ packet to the RS2 and then MS 103, per steps 661 and 663. MS 103 then sends an ACK message back to the BS 101 (steps 665-669).

In an exemplary embodiment, RS1 assumes that the same resources used to transmit the packet to RS2 are reserved for the next retransmission in HARQ_NEXT_RETRAN_DELAY frame. This HARQ_NEXT_RETRANS_DELAY is configurable and indicated to RS in broadcast message. When BS 101 decodes the 2^{nd} code sequence (C₂) in the UL ACK channel, the BS 101 knows that HARQ packet failed at link that is 2 hop away (i.e., at RS2). Therefore, the BS 101 knows that RS1 will retransmit the same packet again in frame N+HARQ_DL_ACK_DELAY+HARQ_NECT_RETRANS_DELAY.

With respect to FIG. 6D, BS 101 sends the HARQ packet to RS1, per step 681. However, this transmission fails at RS1, which detects such a failure (step 683). Accordingly, upon detection of the failure, the RS1 transmits the original NAK code sequence defined for 1^{st} hop (C₁) to BS 101, per step 685. Again, the original NAK code implies the same sequence as defined in, for example, IEEE 802.16e-2005 standard for NAK.

In step 687, BS 101 retransmits the HARQ packet to the RS1, which the forwards the packet to RS2, and subsequently the destination node, MS 103 (steps 689-691). In turn, MS 103 responds with an ACK, per steps 693-697.

Table 4 depicts, according to one embodiment, the protocol function using the sequence defined in Table 3b for the multi-hop relay example under consideration. It is contemplated that the enhance H-ARQ scheme can be extended to multiple links. In particular, Table 4 provides an example of UL ACK/NAK message encoding, transmission and interpretation for the enhanced H-ARQ scheme for a multi-hop network with 2 relay stations between BS and MS/SS:

TABLE 4

| H-ARQ Attempt (PASS/FAIL) | | | UL ACK/NAK Message | | | |
|---|---|---|---|---|---|---|
| Link-1 | Link-2 | Link-3 | Link-3 | Link-2 | Link-1 | BS Infers |
| PASS | PASS | PASS | 0, 0, 0 | 0, 0, 0 | 0, 0, 0 | C0: Successful |
| | | | | | | transmission |
| PASS | PASS | FAIL | 4, 7, 2 | 3, 5, 1 | 6, 2, 3 | C3: Link-3 failed, other |
| | | | | | | links are okay |
| PASS | FAIL | —¹ | — | 4, 7, 2 | 3, 5, 1 | C2: Link-2 failed, Link-1 |
| | | | | | | okay, no transmission |
| | | | | | | beyond link-2 |
| FAIL | — | — | — | — | 4, 7, 2 | C1: Link-1 failed, no |
| | | | | | | transmission beyond link-1 |

¹No ACK/NAK message is transmitted as the there was no transmission on the specified link due to a failure at some earlier link

According to an exemplary embodiment, the encoding algorithm for UL ACK/NAK message can be described as follows:

----------------------------------
@ MS:

if (DL_HARQ_ATTEMPT == SUCCESS)

Send UL ACK code: C₀

else

Send UL NAK code: C₁

end

@ RS:

if (DL_HARQ_ATTEMPT == SUCCESS)

if (UL_HARQ_ACKNAK_CODE == C₀)

Send UL ACK code: C₀

else (UL_HARQ_ACKNAK_CODE == Cₖ, k ≠ 0)

Send UL ACK code: Cₖ₊₁

else

Send UL NAK code: C₁

end

----------------------------------
BS Interprets:

if (UL_HARQ_ACKNAK_CODE == C₀)

Transmission Okay

elseif (UL_HARQ_ACKNAK_CODE == Cₖ)

Link # k is Failed. No transmission beyond link-k for the
same sub-packet
Reserve downlink resources for HARQ re-transmission
Reserve uplink ACK/NAK resources (simply keep the current
UL ACK/NAK
resources for the failed packet)

end

----------------------------------

It is noted that more sequences can be defined by utilizing the vectors defined in Table 2, such that these sequences are orthogonal to each other. Also, different combination can also be defined from these vectors such that all combinations are orthogonal to each other. Furthermore, it is also possible to define a new set of orthogonal sequences and use them to create the H-ARQ ACK/NAK code sequences as specified in Table 3a or Table 3b.

Since retransmission is performed by RS 105 where the HARQ packet is not successfully delivered to another RS 105 or MS 103, the UL ACK channel resources are assigned by BS 101 to deliver the outcome to the retransmission. This is required for BS 101 to know if any of the subsequent re-transmission by any of the RS 105 is successful. This mechanism allows end-to-end signaling between BS and MS/SS for H-ARQ. To transmit the outcome of the retransmitted packet by RS 105, BS 105 maintains the same UL ACK region for the RS(s) to transmit feedback. BS 101 may broadcast/transmit empty map message to avoid any spurious transmission by any other RS(s) 105 or MS/SS 103 in the reserved region in UL. This mechanism avoids overhead of further UL resource reservation by RSs 101 or BS 101. If the BS 101 does not receive ACK code sequence (C₀), after the pre-determined maximum number of re-transmissions (re-transmission by other RS, BS just verifies ACK message in UL), both RS 105 and BS 101 discard the packet and clear the queue. BS 101 can then perform normal signaling as if packet is not received by MS 103 when maximum re-transmissions are exhausted.

For the uplink, there is no downlink (DL) ACK channel defined in IEEE 802.16e-2005. Instead the ACK/NAK messages of received HARQ packets are sent by BS 101 in the DL ACK/NAK bitmap. Thus, according to an exemplary embodiment, the RS 105 in the chain that received the UL HARQ packets successfully, queues the packet and transmits such packet to the next hop. If packet transmission fails at RSx, the relay station requests bandwidth to transmit feedback information. Feedback information can contain, for instance, the RSID, HARQ packet info (MSID, Channel ID, sequence number, etc.) so that BS 101 knows where the packet is lost so that it can schedule resources from RSx to BS. Each RS 105 generates the ACK/NAK bitmaps for downstream node based on the ACK/NAK bitmap received from the upstream node.

Other implementation details, according to various embodiments, are further detailed in the Appendix.

The above arrangement, according to certain embodiments, provides a number of advantages. For example, when an encoder packet is successfully received and decoded by a RS 105, the RS 105 can perform as one end of the H-ARQ scheme, and therefore, the resource used to transmit subsequent H-ARQ attempt in the case of loss or error between BS 101 and RS 105 can be saved and used for other transmissions. Also, no explicit resources are required to send feedback information. Furthermore, in the subsequent retransmission, no explicit MAP (Media Access Protocol) messages are required to reserve UL or DL radio resources. Additionally, retransmission is performed faster by RS 105. BS 101 keeps the resources reserved for the retransmission and UL ACK/NAK messages. The enhanced H-ARQ scheme, in one embodiment, utilizes already defined code sequence of UL ACK Channel.

One of ordinary skill in the art would recognize that the processes for providing error control in a multi-hop communication system may be implemented via software, hardware (e.g., general processor, Digital Signal Processing (DSP) chip, an Application Specific Integrated Circuit (ASIC), Field Programmable Gate Arrays (FPGAs), etc.), firmware, or a combination thereof. Such exemplary hardware for performing the described functions is detailed below with respect to FIG. 6.

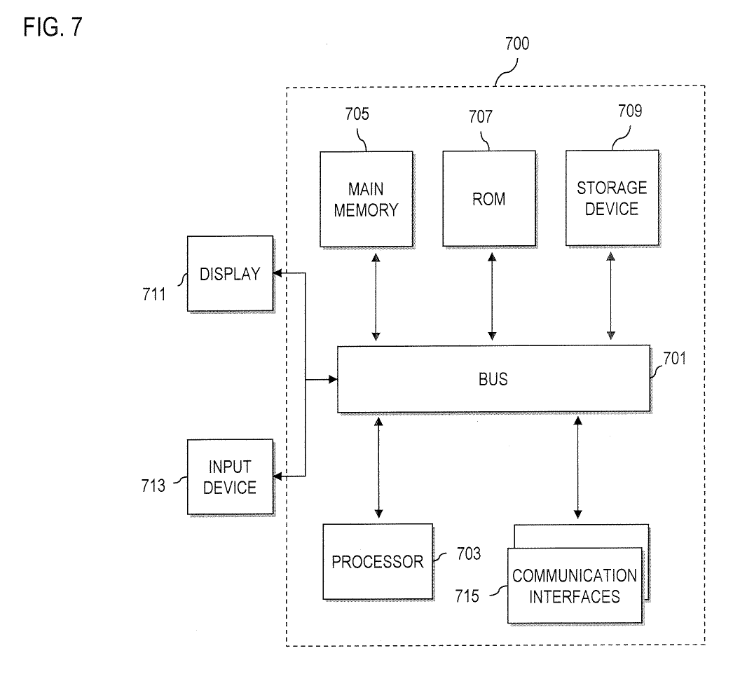

FIG. 7 illustrates exemplary hardware upon which various embodiments of the invention can be implemented. A computing system 700 includes a bus 701 or other communication mechanism for communicating information and a processor 703 coupled to the bus 701 for processing information. The computing system 700 also includes main memory 705, such as a random access memory (RAM) or other dynamic storage device, coupled to the bus 701 for storing information and instructions to be executed by the processor 703. Main memory 705 can also be used for storing temporary variables or other intermediate information during execution of instructions by the processor 703. The computing system 700 may further include a read only memory (ROM) 707 or other static storage device coupled to the bus 701 for storing static information and instructions for the processor 703. A storage device 709, such as a magnetic disk or optical disk, is coupled to the bus 701 for persistently storing information and instructions.

The computing system 700 may be coupled via the bus 701 to a display 711, such as a liquid crystal display, or active matrix display, for displaying information to a user. An input device 713, such as a keyboard including alphanumeric and other keys, may be coupled to the bus 701 for communicating information and command selections to the processor 703. The input device 713 can include a cursor control, such as a mouse, a trackball, or cursor direction keys, for communicating direction information and command selections to the processor 703 and for controlling cursor movement on the display 711.

According to various embodiments of the invention, the processes described herein can be provided by the computing system 700 in response to the processor 703 executing an arrangement of instructions contained in main memory 705. Such instructions can be read into main memory 705 from another computer-readable medium, such as the storage device 709. Execution of the arrangement of instructions contained in main memory 705 causes the processor 703 to perform the process steps described herein. One or more processors in a multi-processing arrangement may also be employed to execute the instructions contained in main memory 705. In alternative embodiments, hard-wired circuitry may be used in place of or in combination with software instructions to implement the embodiment of the invention. In another example, reconfigurable hardware such as Field Programmable Gate Arrays (FPGAs) can be used, in which the functionality and connection topology of its logic gates are customizable at run-time, typically by programming memory look up tables. Thus, embodiments of the invention are not limited to any specific combination of hardware circuitry and software.

The computing system 700 also includes at least one communication interface 715 coupled to bus 701. The communication interface 715 provides a two-way data communication coupling to a network link (not shown). The communication interface 715 sends and receives electrical, electromagnetic, or optical signals that carry digital data streams representing various types of information. Further, the communication interface 715 can include peripheral interface devices, such as a Universal Serial Bus (USB) interface, a PCMCIA (Personal Computer Memory Card International Association) interface, etc.

The processor 703 may execute the transmitted code while being received and/or store the code in the storage device 709, or other non-volatile storage for later execution. In this manner, the computing system 700 may obtain application code in the form of a carrier wave.

The term “computer-readable medium” as used herein refers to any medium that participates in providing instructions to the processor 703 for execution. Such a medium may take many forms, including but not limited to non-volatile media, volatile media, and transmission media. Non-volatile media include, for example, optical or magnetic disks, such as the storage device 709. Volatile media include dynamic memory, such as main memory 705. Transmission media include coaxial cables, copper wire and fiber optics, including the wires that comprise the bus 701. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the invention may initially be borne on a magnetic disk of a remote computer. In such a scenario, the remote computer loads the instructions into main memory and sends the instructions over a telephone line using a modem. A modem of a local system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

### APPENDIX

Relay Support for UL HARQ in Centralized Scheduling:

Base station (e.g., multi-hop relay base station (MR-BS) 101 schedules an initial transmission of HARQ packet on all the links between MR-BS 101 and MS/SS 103. UL transmission failure on a relay link is indicated by an encoded ACK/NAK on the UL ACK Channel. Burst allocations for UL HARQ retransmissions can be signaled to the intermediate RSs 105 on the N-hop path between a source MS and the BS 101 in the HARQ UL MAP IE (information element).

The HARQ UL MAP IE defines one or more bursts. Each burst is separately encoded. If MAC tunneling is used, tunnel CID (Connection Identifier) should be used as RCID (Reduced CID) in the related UL HARQ sub-burst IE for the corresponding sub-burst.

It also schedules the bandwidth for relaying upstream ACK/NACK on the UL ACK channel from RS 105 to BS 101. If a packet fails at any of the intermediate RSs 105, the RS 105 transmits code C1 defined in the Table 3a as a NAK back to the previous Infra Station (IS) and transmits to the next hop station the pilot subcarriers and may transmit null data subcarriers. It cannot re-encode the erroneous packet to transmit to the next hop station. Subsequently, the BS 101 may schedule a retransmission on the failed link as well as on all the subsequent links. Every ACK/NACK on UL ACK channel is forwarded by upstream RS(s) 105 and finally to the BS 101. BS 101 identifies the multi-hop link(s) of UL transmission failure by checking the received encoded ACK/NACK. BS 101 may schedule multiple retransmissions in advance on the UL access links. The allocation of retransmissions is at the discretion of the BS 101, but a retransmission may be scheduled no sooner than the preceding transmission plus “HARQ ACK Delay for UL Burst” on the UL access link.

UL HARQ for Transparent RS:

When the MR-BS 101 chooses to receive an HARQ sub-burst from the MS 103 through the RS 105, it can inform the RS 105 and allocate UL transmission for the RS 105 to relay the burst to the MR-BS 101. If an RS 105 receives a HARQ subburst from an MS 103 correctly, the RS 105 saves it for any possible retransmission, and sends an ACK signal to the MR-BS 101 using the ACK channel prepared by MR-BS 101. Then the MR-BS 101 allocates bandwidth for the RS 105 to relay the HARQ sub-burst. If the MR-BS 101 receives ACK signal from the RS 105, it sends an ACK on HARQ ACK Bitmap IE to the MS 103 directly. MR-BS 101 cannot send ACK or NAK signal to RS 105. If the MR-BS 101 cannot decode the sub burst relayed by the RS 105 correctly, the MR-BS 101 allocates bandwidth for the RS 105 to retransmit the saved sub burst. If the MR-BS 101 decodes the sub burst relayed by the RS 105 correctly, it cannot send ACK to RS 105. When RS 105 receives the request to transmit new HARQ sub-burst for the same HARQ channel, it interprets that previous HARQ sub-burst is received successfully.

If an RS 105 fails to receive the HARQ sub-burst from MS 103 correctly, the RS 105 sends a NAK signal to the MR-BS 101 and the MR-BS 101 sends a NAK to the MS 103. Subsequently, the MR-BS 101 may request the MS 103 to retransmit the HARQ sub-burst. It is also possible for the MR-BS 101 to receive the first transmission from an MS directly. In such a case, the MR-BS 101 informs the RS 105 using the MR_UL MAP MONITOR IE that it needs to monitor the transmission. The RS 105, having the information on uplink resource allocations sent in the UL MAP for the MS 103, monitors the HARQ sub burst transmission sent by the MS 103 to the MR-BS 101 directly and attempts to decode it. When the RS 105 receives the HARQ sub burst correctly, the RS 105 saves it for a possible retransmission and sends an ACK to the MR-BS 101.

On receiving the ACK from RS 105, MR-BS 101 sends an ACK on HARQ ACK Bitmap IE to the MS 103 directly. If the burst is received incorrectly at the RS 105 the RS 105 sends a NAK to MR-BS 101. If MR-BS 101 did not receive the HARQ sub-burst from the MS 103 correctly and received a NAK from the RS 105, the MR-BS 101 sends NAK on HARQ ACK Bitmap IE to the MS 103. Subsequently, the MR-BS 101 may request the MS 103 to retransmit the HARQ sub-burst. If MR-BS 101 receives the HARQ sub-burst from the MS 103 correctly then regardless of the ACK/NAK received from the RS 105, the MR-BS 101 sends ACK on HARQ ACK Bitmap IE to the MS 103.

RS Group Assisted HARQ:

Multiple transparent RSs 105 can also be involved in the two-hop HARQ process. The schedule of source station transmitting a sub-burst to multiple transparent RSs 105 may be signaled by using Compact UL-MAP MONITOR IF which points to the burst to be received by the RSs 105. RSs 105 use shared ACK channel to report status to MR-BS 101. BS 101 replies an ACK to MS 103 if it receives the ACK from RS 105; otherwise, it replies NAK to MS 103. If the MR-BS does not receive the ACK from the RSs 105, the BS 101 can arrange data retransmission for the access link. If the BS 101 receives the ACK from the RSs 105 but fails to decode the sub-burst, the BS 101 can arrange data retransmission for the relay link.

Hop-by-Hop HARQ:

In case of hop-by-hop HARQ involving multiple RSs 105, HARQ data is scheduled and forwarded to the MR-BS 101 when BS 101 receives from the RSs 105 the ACK on shared CK channel. If an RS 105 receives the HARQ sub burst from the MS 103 correctly, then the RS 105 stores HARQ sub-burst and reports ACK to BS 101. If an RS 105 fails to decode the sub-burst correctly, it can transmit nothing in the ACK channel. If BS 101 receives the ACK, it schedules RS(s) 105 to forward HARQ sub-burst to BS 101. For RSs 105 that report the ACK to BS 101, RS can forward stored HARQ sub-burst to BS 101. For RS 105 who does not report the ACK to BS 101, it cannot transmit the erroneous packet to the BS 101.

End-to-End HARQ:

In case of multiple RSs 105 and the resource is prescheduled for all links, the BS 101 allocates UL transmission for the RS 105 to relay the received sub-burst from MS 103 to the BS 101 and allocates one shared ACK channel for RSs 105 to send an ACK signal to the BS 101. If an RS 105 receives the HARQ sub burst from the MS 103 correctly, then the RS 105 forwards HARQ sub-burst to the BS 101 and reports an ACK to BS 101. If an RS 105 fails to decode the sub-burst correctly, it cannot transmit the erroneous packet to the BS 101, and it can transmit nothing in the ACK channel. If the BS 101 receives ACK report but fails to decode the data, it should perform retransmission only for the relay link. If it does not receive ACK, it can schedule the retransmission across all hops.

UL HARQ for Non-Transparent RS:

When MR-BS 101 schedules a HARQ attempt, it allocates bandwidth over all the links from the MS to the MR-BS 101. It also allocates bandwidth for the ACK/NAK channel on the relay links between access RS 105 and MR-BS 101. Each RS 105 on the relay path receives the uplink HARQ burst, and decodes it. If the decoding succeeds, it forwards the HARQ burst to the next IS along with an ACK. If the decoding fails, the RS 105 only sends an encoded NAK to the next IS. In case of multiple hop, each subsequent RS 105 in the path places encoded NAK according to Tables 3a and 3b. In case of two hops, encoded NAK is not needed. Encoded NAK informs MR-BS 101 where the packet transmission was unsuccessful. If RS 105 receives the encoded NAK Cx (x not equal to 0) than it will send the encoded NAK Cx+1 to next hop RS/MR-BS. If MR-BS 101 receives encoded NAK Cx then it knows that packet is failed on x+1 hop from MR-BS 101, therefore it will schedule retransmission only on the failed links. The MR-BS 101 sends UL-MAP accordingly, allowing retransmission from the last RS onwards, thus, retransmitting only on the links that didn't relay the HARQ burst successfully. The receiving RS 105 first looks at the per hop ACK channel. If it receives encoded NAK, it discards any information received in the HARQ, and sends encoded NAK to the next IS. If it receives ACK, it decodes the HARQ burst.

The ACK/NAK is sent in HARQ ACK Bitmap IE. Each RS 105 also generates per hop HARQ ACK bitmap IE for its received HARQ bursts. Each receiving RS 105/MR-BS 101 keeps its mapping, and generates its HARQ ACK bitmap accordingly. The MR-BS 101 allocates the resource to transmit HARQ ACK bitmap IE from each RS 105. The receiver of the bitmap clears the buffer corresponding to the ACK bits in the bitmap, and saves the buffer corresponding to the NAK bits.

HARQ ACK Region Allocation IE:

This IE may be used by MR-BS 101 to define an ACK channel region on the R-UL to include one or more ACK channel(s) for RS 105. In the case of a transparent RS 105, the RS 105 that receives HARQ UL sub burst from MS 103 for relaying to MR-BS 101 at frame i can transmit the ACK/NAK signal through the ACK Channel in the ACKCH region for UL MS data at frame (i+k). The frame offset k is defined by the “HARQ ACK Delay for UL Burst for MR” field in the UCD message.

In the case of a non-transparent RS 105, the RS 105 that receives HARQ UL sub burst, from MS 103 or sub-ordinate RS 105 for relaying to BS 101 at frame i can transmit the ACK/NAK signal through the ACK Channel in the ACKCH region along with the UL MS HARQ sub-burst at frame (i+k). The RS 105 can transmit the ACK/NAK signal according to the order of UL HARQ sub-burst in the UL-MAP. The frame offset k is defined by the “HARQ ACK Delay for UL Burst for MR” field in the UCD message. Table (i) provides HARQ_ACKCH region allocation for UL Data IE.

TABLE i

| | | |
|---|---|---|
| Syntax | Size | Notes |

HARQ_ACKCH_Region_for Relay Data IE( ) {

| | | |
|---|---|---|
| Extended-2 UIUC | 4 bits | HARQ ACKCH Region for Relay Data IE = 0x09 |
| Length | 8 bits | Length in bytes |
| Direction | 1 bit | 0 = IE is related to UL HARQ Data IE |

1 = IE is related to DL HARQ Data IE

If (direction == 1) {

| | |
|---|---|
| N_hop | 4 bits |
| for (i = 0: i < N_hop: i++) { | |

| hop_depth | 3 bits | B000 and b001 are invalid. When MR-BS/RS |
|---|---|---|
| | | transmits HARQ burst for the n-hop away |
| | | MSs it shall set hop_depth = n. |
| Reserved | 1 bit | |
| ACKCH_offset | 8 bits | ACKCH_offset indicates the starting |

point in the ACKCH region for sending
HARQ ACK/NAK for corresponding
hop_depth.

}

} else {

| | |
|---|---|
| Reserved | 3 bits |

| } | |
|---|---|
| OFDMA Symbol | 8 bits |
| Subchannel offset | 7 bits |
| No. OFDMA symbols | 5 bits |
| No. subchannels | 4 bits |

}

Delay Support for DL HARQ in Centralized Scheduling:

MR-BS 101 schedules an initial transmission of HARQ packet on all the links between MR-BS 101 and MS 103. DL transmission failure on a relay link is indicated by an encoded ACK/NAK on the UL ACK Channel. HARQ_DL_MAP_IE as defined below be used to signal the HARQ burst allocations to the intermediate RSs 105 along the path. MR-BS 101 also allocates bandwidth for relaying upstream ACK/NAK on the UL ACK channel for all the hops from MS 103 to MR-BS 101. Table (ii) provides RS HARQ DL MAP IE Format on Relay Links.

TABLE ii

| Mode | 4 bits | Indicates the mode of this HARQ region |
|---|---|---|
| | | 0b000 = Chase HARQ |
| | | 0b0001 = Incremental redundancy HARQ for CTC |
| | | 0b0010 = Incremental redundancy HARQ for Convolu- |
| | | tional Code |
| | | 0b0011 = MIMO Chase HARQ |
| | | 0b0100 = MIMO IR HARQ |
| | | 0b0101 = MIMO IR HARQ for Convolutional |
| | | Code |
| | | 0b0110 = MIMO STC HARQ |
| | | 0b0111-0b111 Reserved |
| Sub-burst IE Length | 8 bits | Length in nibbles, to indicate the size of the sub-burst |
| | | IE in this HARQ mode. The MS may skip DL HARQ |
| | | sub-burst IE if it does not support the HARQ Mode. |
| | | However, the MS shall decode NACK Channel field |
| | | from each DL HARQ sub-burst IE to determine the UL |
| | | ACK channel it shall use for its DL HARQ burst. |
| If (Mode == 0b0000) { | — | — |

| | | |
|---|---|---|
| DL HARQ Chase sub-burst IE( ) | Variable | — |

| | | |
|---|---|---|
| } else if (Mode == 0b0001) { | — | — |

| | | |
|---|---|---|
| DL HARQ IR CTC sub-burst IE( ) | Variable | — |

| | | |
|---|---|---|
| } else if (Mode == 0b0010) { | — | — |

| | | |
|---|---|---|
| DL HARQ IR CC sub-burst IE( ) { | Variable | — |

| | | |
|---|---|---|
| } else if (Mode==0b0011) { | — | — |

| | | |
|---|---|---|
| MIMO DL Chase HARQ Sub-Burst IE ( ) | Variable | — |

| | | |
|---|---|---|
| } else if (Mode==0b0100) { | — | — |

| | | |
|---|---|---|
| MIMO DL IR HARQ Sub-Burst IE ( ) | Variable | — |

| | | |
|---|---|---|
| } else if (Mode==0b0101) { | — | — |

| | | |
|---|---|---|
| MIMO DL IR HARQ for CC Sub-Burst | Variable | — |

IE ( )

| | | |
|---|---|---|
| } else if (Mode == 0b0110) { | — | — |

| | | |
|---|---|---|
| MIMO DL STC HARQ Sub-Burst IE ( ) | Variable | — |
| } | — | — |

| | | |
|---|---|---|
| } | — | — |
| Padding | Variable | Padding to byte, shall be set to 0 |

| | | |
|---|---|---|
| } | — | — |

If a packet fails at any of the intermediate RSs 105, the RS 105 transmits code C1 defined in the Table 3b as a NAK back to the previous IS and transmits to the next hop station the pilot subcarriers and may transmit null data subcarriers. The RS 105 cannot transmit the erroneous packet to the next hop station. Subsequently, the MR-BS 101 may schedule a retransmission on the failed link as well as on all the subsequent links. In case of a HARQ sub burst decoding error, the RS 105 replaces the RCID_IE in the corresponding HARQ sub burst IE with its own RCID_IE. MR-BS 101 may schedule multiple retransmissions in advance on the DL access links. The allocation of retransmissions is at the discretion of the MR-BS 101, but a retransmission may be scheduled no sooner than the preceding transmission plus “HARQ ACK Delay for DL Burst” on the DL access link. The number of prescheduled retransmissions for a HARQ flow may be provided to the access RS 105 from the MR-BS 101 in the “hop_depth” field of the RS_HARQ_DL_MAP_IE.

DL HARQ for Transparent RS: RS Hop-by-Hop HARQ:

When MR-BS 101 or RS 105 sends a HARQ sub burst to MS 103 through RS 105, the RS 105 can receive the HARQ sub burst from the MR-BS 101 or relaying the burst to the MS 103. If the RS 105 receives the HARQ sub burst correctly, then the RS 105 sends an ACK signal to the MR-BS 101 and saves it for the event that there maybe a retransmission to MS 103. Subsequently, the RS 105 forwards the sub burst to the MS 103. If the RS 105 does not receive the HARQ sub burst successfully, the RS 105 can send a NACK signal to the BS 101. Upon receiving the NACK from the RS 105, the BS 101 can retransmit the HARQ sub burst to the RS 105. When HARQ sub-burst is successfully received at RS 105, BS 101 request RS 105 to transmit HARQ sub-burst. When the MR-BS 101 receives a NACK from the MS 103, the BS 101 notifies the RS 105 to retransmit the HARQ sub burst to the MS 103, and the RS 105 can retransmit the stored correct HARQ sub burst to the MS 103.

DL HARQ for Non-Transparent RS:

DL transmission failure on a relay link can be indicated by the orthogonal code on the UL ACK Channel. The MR-BS 101 identifies the RS 105 for retransmission using ACK/NACK encoding in Table 3a. This does not require each RS 105 on the path and MS 103 to send separate ACK/NAK signals back to the MRBS 101; thus, conserves the bandwidth by utilizing the same ACK channel. When MR-BS 101 sends the first HARQ attempt, it allocates bandwidth over all the links from the MR-BS 101 to the MS103. Each RS 105 on the relay path receives the downlink HARQ packet, and decodes it. If the decoding succeeds, RS 105 forwards the HARQ packet to the next hop and waits for the UL ACK from the next-hop RS 105 or MS 103.

When a RS 105 receives code C0, indicating that the HARQ packet is successfully received by the next station, it sends code C0 to the previous IS on its UL ACK channel. When a RS 101 receives code Ck, or NAK from the SS 103, it sends UL ACK code=Ck+1 or C2 respectively on its UL ACK channel. MR-BS 101 upon receipt of kth hop code sequence (Ck) in UL ACK Channel assumes that packet is lost on the link that is the kth hop, and it will schedule retransmission from (k−1)th RS 105. If MR-BS 101 receives code C0, it indicates that the HARQ packet is successfully received by SS 103. If MR-BS 101 receives code C1, it indicates that the HARQ packet is failed on the first hop.

When the orthogonal encoded UL ACK scheme is employed, the UL ACK channel resources can be assigned so that the UL ACK channel from MS 103 to its previous RS first and up to BS 101 in reverse order of the DL transmission path. If, the MR-BS 101 does not receive ACK code sequence (C0), in the prescribed number of re-transmissions, both RS 105 and BS 101 will discard the packet and clear the queue. BS 101 can then perform normal signaling as if the packet is not received by MS 103.

MR-BS 101 can allocate the HARQ region which contain bursts destined to MSs 103 which have same number of hops away in common by using RS HARQ DL MAP IE. Similarly MR-BS 101 can allocate ACKCH by using HARQ_ACKCH region allocation for Relay Data IE. MR-BS 101 can indicate the hop_depth in RS HARQ DL MAP IE as well as in HARQ_ACKCH region allocation for Relay data IE so that RS 105 can map the HARQ burst and corresponding HARQ ACK/NAK accordingly.

DL Hop-by-Hop HARQ for Multi-Hop Non-Transparent RS with Distributed Scheduling:

The hop-by-hop HARQ can be used for distributed scheduling RS 105 scenarios. In the hop-by-hop design, each hop can use independent HARQ transactions between a station (which may be MR-BS 101 or an intermediate RS 105). For hop-by-hop HARQ, the HARQ transactions can adhere to the same protocols and procedures as between a BS 101 and MS103 in a non-relay network.

RS Assisted HARQ:

In a case where the MR-BS 101 sends a HARQ sub-burst to the MS directly, the MR-BS 101 informs the RS 105 that it needs to monitor that particular transmission by MR_DL-MAP MONITOR IE and also allocate HARQ ACK region allocation IE on the relay link for sending ACK/NACK from RS 105. The RS 105, having information on the downlink resource allocations sent in the DL MAP for the MS 103 and MR_DL-MAP MONITOR IE, monitors the HARQ sub burst transmission sent to MS 103 by MR-BS 101 directly and attempts to decode it. When the RS 105 receives the HARQ sub burst correctly, the RS 105 saves it for a possible retransmission. When MR-BS 101 receives ACK/NACK from MS 103 directly, MR-BS 101 informs RS 105 to reply ACK/NACK signal after RS 105 receives the HARQ sub-burst. In this case, MR-BS 101 receives ACK/NACK from RS 105 and MS 103 separately. When MR-BS 101 receives NACK from both RS 105 and MS 103, MR-BS 101 retransmits the HARQ sub-burst. If MR-BS 101 receives ACK from RS 105 and NACK from MS 103, MS-BS 101 makes the RS 105 retransmits the HARQ subburst.

RS 105 will send the ACK/NAK in the UL ACKCH according to the order of CID in the MR_DL-MAP MONITOR IE. MR-BS 101 may also configure RS 105 to listen the ACK/NACK from the MS 103 using MR_DL-MAP MONITOR IE. After the RS 105 receives ACK/NACK from the MS 103, the RS 105 replies using an encoded ACK/NACK defined in Table xxx through ACK channel prepared by MR-BS 101. RS 105 can clear the HARQ sub-burst depending upon the ACK/NACK information received from MS 103. If the RS 105 received the HARQ sub-burst correctly and receives a NACK from MS 103, the RS 105 replies the C2 to MR-BS 101. In this case, the MR-BS 101 requests the RS 105 to retransmit the HARQ sub-burst saved at the RS 105. When the RS 105 fails to receive the HARQ sub-burst and receives a NACK from the MS 103, the RS 105 sends a NACK to the MR-BS 101. Then the MR-BS 101 retransmits the burst by itself. When the RS 105 receives an ACK from MS 103 then irrespective of whether RS 105 receives the HARQ subburst correctly or not, the RS 105 replies ACK to the MR-BS 101. RS 105 will send the encoded ACK/NACK in the UL ACKCH according to the order of CID in the MR_DL-MAP MONITOR IE. Multiple transparent RSs 105 can also be involved in the HARQ process. The schedule of source station transmitting a sub-burst to multiple transparent RSs 105 can be signaled by using MR_DL-MAP MONITOR IE which points to the burst to be received by the RSs 105. If an RS 105 fails to decode the burst correctly, it cannot transmit the erroneous packet to the next hop station. In case of hop-by-hop HARQ involving multiple RSs 105, HARQ data is scheduled and forwarded to the next hop when MR-BS 101 receives an ACK from at least one of the RSs 105, and the MR-BS 101 can schedule one or more RSs 105 that sent ACK to forward the data to the next hop. In case of multiple RSs 105 when the resource is prescheduled for all the links, one of the RSs 105 can be selected as designated RS 105 per hop, which is responsible for forwarding and reporting status to MR-BS 101 in addition to the data forwarding. The designated RS 105 waits for the UL ACK from the next-hop RS 105 or MS 103 after it forwards the HARQ packet or transmits the pilots to the next hop. If MS 103 sends an ACK, the designated RS 105 reports a C0 code; otherwise the designated RS 105 replies by choosing C2 from Table 3a and 3b.

HARQ ACK Region Allocation IE (DL Sub-burst Case):

When RS 105 receives HARQ DL sub-burst for relaying to MS 103 at frame i, it can transmit the encoded ACK/NAK signal through ACK Channel in the ACKCH region at frame (i+n) where n is calculated at each RS according to the following equation. 5

n=(H−1)*p+H*j

H is equal to “hop_depth” transmitted in RS HARQ DL MAP IE and HARQ_ACKCH region allocation for relay Data IE. It represents number of hops BS 101/RS 105 is away from the MS. p is defined by the “HARQ_burst_Delay for DL Burst” field in the DCD (Downlink Channel Descriptor) messages. j is defined by the “HARQ_ACK_Delay for DL Burst” field in the DCD messages. It is applicable to both RS and MS. In 2-hop case, there is only one RS and n=p+2*j.

If pre-scheduling of retransmissions on the access link on the DL is enabled, only HARQ flows with the same number of pre-scheduled retransmission attempts can be scheduled into the same HARQ region. An UL HARQ feedback region is allocated in the frame i+n at an RS for a HARQ region received in frame i, where

n=(\tilde{H}−1)×p+\tilde{H}×j

and \tilde{H}=H+k and k denotes the number of pre-scheduled attempts. For pre-scheduled bursts, H is specified in the “hop_depth” field of the RS_HARQ_DL_MAP_IE. At an access RS, H=1, and hence the number of pre-scheduled attempts for a HARQ burst can be computed at the access RS as k=\tilde{H}−1.

If pre-scheduling of retransmissions on the access link on the UL is enabled, only ACK/NACK feedback for not-prescheduled bursts or for pre-scheduled bursts that have reached the maximum number of pre-scheduled attempts is to be forwarded to the MR-BS in the allocated UL HARQ ACKCH region.

What is claimed is:

1. A method comprising:
determining a first node that failed to transmit a packet generated according to an error-control scheme, wherein the first node is among a plurality of nodes configured to operate in a multi-hop network; and
reserving resources of the multi-hop network only for retransmission of the packet from the first node towards a destination node that is included in the plurality of nodes.

2. A method according to claim 1, wherein the error-control scheme includes hybrid automatic repeat request (HARQ).

3. A method according to claim 1, wherein the network is compliant with an Institute of Electrical and Electronic Engineers (IEEE) 802.16 architecture.

4. A method according to claim 1, wherein the transmission failure is indicated by a control signal on an uplink acknowledgement channel, the method further comprising:
scheduling a plurality of retransmissions of the packet after a predetermined period of delay after a preceding transmission of the packet.

5. A method according to claim 1, further comprising:
receiving, over an uplink acknowledgement channel, an encoded acknowledgement message that indicates the transmission failure.

6. A method according to claim 1, further comprising:
signaling depth of the hops to the first node.

7. A method according to claim 1, wherein the nodes include relay nodes, each of the relay nodes being configured to generate a map of acknowledgment bits corresponding to received acknowledgements of transmissions of the packet from a neighboring one of the relay nodes.

8. A method according to claim 1, wherein the nodes include a base station, a mobile station, and at least one relay station, the method further comprising:
instructing the relay station to monitor transmission of a sub-burst that was transmitted by the base station to the mobile station, wherein the relay station stores the sub-burst for possible retransmission.

9. An apparatus comprising:
a scheduler configured to determine a first node that failed to transmit a packet generated according to an error-control scheme, the first node being among a plurality of nodes configured to operate in a multi-hop network,
wherein resources of the multi-hop network are reserved only for retransmission of the packet from the first node towards a destination node that is included in the plurality of nodes.

10. An apparatus according to claim 9, wherein the error-control scheme includes hybrid automatic repeat request (HARQ).

11. An apparatus according to claim 9, wherein the network is compliant with an Institute of Electrical and Electronic Engineers (IEEE) 802.16 architecture.

12. An apparatus according to claim 9, wherein the transmission failure is indicated by a control signal on an uplink acknowledgement channel, the scheduler being further configured to schedule a plurality of retransmissions of the packet after a predetermined period of delay after a preceding transmission of the packet.

13. An apparatus according to claim 9, further comprising:
a communication interface configured to receive, over an uplink acknowledgement channel, an encoded acknowledgement message that indicates the transmission failure.

14. An apparatus according to claim 9, wherein the logic is further configured to signal depth of the hops to the first node.

15. An apparatus according to claim 9, wherein the nodes include relay nodes, each of the relay nodes being configured to generate a map of acknowledgment bits corresponding to received acknowledgements of transmissions of the packet from a neighboring one of the relay nodes.

16. An apparatus according to claim 9, wherein the nodes include a base station, a mobile station, and at least one relay station, the scheduler being further configured to instruct the relay station to monitor transmission of a sub-burst that was transmitted by the base station to the mobile station, wherein the relay station stores the sub-burst for possible retransmission.

17. An apparatus according to claim 16, wherein the mobile station includes a handset.

18. An apparatus according to claim 9, wherein the apparatus is a base station and is one of the plurality of the nodes.

19. A system comprising:
a plurality of relay stations configured to operate in a multi-hop network; and
a base station configured to communicate with each of the relay stations, wherein the base station is further configured to determine a first relay station, among the plurality of relay stations, that failed to transmit a packet generated according to an error-control scheme, the base station being further configured to reserve resources of the multi-hop network only for retransmission of the packet from the first node towards a destination node that is included in the plurality of nodes.

20. A system according to claim 19, wherein the error-control scheme includes hybrid automatic repeat request (HARQ).

21. A method comprising:
determining transmission failure of a packet generated according to an error-control scheme to a subsequent node among a plurality of nodes of a multi-hop network, wherein the plurality of nodes include a source node and a destination node; and
notifying the source node of the failure to the subsequent node, wherein resources of the multi-hop network are reserved only for retransmission of the packet to the subsequent node towards the destination node.

22. A method according to claim 21, wherein the error-control scheme includes hybrid automatic repeat request (HARQ).

23. An apparatus comprising:
logic configured to determine transmission failure of a packet generated according to an error-control scheme to a subsequent node among a plurality of nodes of a multi-hop network, wherein the plurality of nodes include a source node and a destination node,
wherein the logic is further configured to notify the source node of the failure to the subsequent node,
wherein resources of the multi-hop network are reserved only for retransmission of the packet to the subsequent node towards the destination node.

24. An apparatus according to claim 23, wherein the error-control scheme includes hybrid automatic repeat request (HARQ).
